(19) United States
(12) Patent Application Publication
(10) Pub. No.: US 2023/0229397 A1
(43) Pub. Date: Jul. 20, 2023

(54) MULTIPLICATION BY A RATIONAL IN HARDWARE WITH SELECTABLE ROUNDING MODE

(71) Applicant: Imagination Technologies Limited, Kings Langley (GB)

(72) Inventor: Thomas Rose, Watford (GB)

(21) Appl. No.: 18/072,463

(22) Filed: Nov. 30, 2022

(30) Foreign Application Priority Data
Nov. 30, 2021 (GB) 2117313.3

(51) Int. Cl. G06F 7/544; G06F 7/499; G06F 30/392

(52) U.S. Cl. CPC G06F 7/5443; G06F 7/49947; G06F 30/392

(57) ABSTRACT

A fixed logic circuit for performing multiplication of an input x by a constant rational p/q so as to calculate an output y according to a directed rounding or round-to-nearest rounding mode. Fixed logic hardware is derived comprising an addition array configured to operate on canonical signed digit (CSD) forms of binary values (a CSD array) so as to form an approximation of a multiplication of an input x [m−1:0] by a rational p/q. A truncated summation array of a finite sequence of most significant bits of an infinite CSD expansion of the rational p/q operating on the bits of the input x satisfies

$${Δ}_{high} - {Δ}_{low} < \frac{1}{q} .$$

Registers define a plurality of corrective constants for a respective plurality of rounding modes, and selection logic selects the respective corrective constant for that rounding mode in dependence on a rounding mode in which the truncated summation array is to operate.

### BACKGROUND

This invention relates to a logic circuit for implementing binary multiplication using a truncated addition array and to a method of deriving a binary logic circuit for performing such multiplication.

When designing integrated circuits, logic is often required to perform addition, subtraction, multiplication and division. Whilst addition, subtraction and multiplication operations can all be cheaply implemented in hardware, division is acknowledged to be an expensive operation to implement in hardware.

In the case that the divisor is known to be a constant at design-time, a division operation can be expressed as multiplication by a constant rational (i.e. a fraction of two integers) and it is possible to construct efficient implementations of the division operation using a combination of addition and constant multiplication logic. This can significantly simplify the logic and hence reduce the area of integrated circuit needed to implement the division operation. For example, if the division operation y=px/q, where p and q are integer constants and x is an integer variable, can be rewritten in the form (ax+b)/2^{k}, then the division operation can be expressed in logic as a multiply-add operation whose result is right-shifted by k binary places.

Another method for performing division by means of multiplication by a constant rational is to take the binary expansion of

$$\frac{p}{q}$$

(typically infinite but recurring) and to consider the infinite addition array formed by multiplication with x. The array may be truncated in such a way as to guarantee that the remaining finite array sums to an answer for y which is faithfully rounded (where faithful rounding is a scheme with an error tolerance which allows rounding towards either positive or negative infinity). For example, UK Patent GB2551725 describes truncating an infinite single summation array representing multiplication by an invariant rational. The truncation is performed by identifying a repeating section of the array and discarding all but a finite number of the repeating sections while satisfying a defined error bound.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

There is provided fixed logic circuit for performing multiplication of an input x by a constant rational p/q so as to calculate an output y according to a directed rounding or round-to-nearest rounding mode, where p, q are coprime integers, and x is an m-bit input, the fixed logic circuit comprising:

a truncated summation array of a finite sequence of most significant bits of an infinite CSD expansion of the rational p/q operating on the bits of the input x, the truncated summation array satisfying

$${Δ}_{high} - {Δ}_{low} < \frac{1}{q} ,$$

where, tor au x, Δ_{high} is the maximum sum of the partial products of the bits of the infinite CSD expansion not included in the array and is the minimum sum of the partial products of the bits of the infinite CSD expansion not included in the array;

registers defining a plurality of corrective constants for a respective plurality of rounding modes, each corrective constant being for use in the fixed logic circuit when the fixed logic circuit is operating in the rounding mode such that the output y is correct for all x; and

selection logic configured to, in dependence on a rounding mode in which the truncated summation array is to operate, select the respective corrective constant for that rounding mode.

The plurality of corrective constants may be each for addition with the output of the truncated summation array.

The selection logic may be configured to select the respective corrective constant for the rounding mode by appropriately configuring a plurality of gates of the fixed logic circuit.

The registers may define a plurality of configurations of the plurality of gates of the fixed logic circuit, each of the plurality of configurations representing a respective corrective constant of the plurality of corrective constants.

The fixed logic circuit may further comprise a set of configurable registers arranged to control a plurality of gates of the fixed logic circuit, the selection logic being configured to set the configurable registers according to the selected respective corrective constant.

The fixed logic circuit may further comprise a set of configurable registers arranged for summation with the truncated summation array, the selection logic being configured to set the configurable registers according to the selected respective corrective constant.

The set of configurable registers are arranged for summation with the truncated summation array such that all the configurable registers are arranged for summation with columns at least as significant as the least significant column of the truncated summation array.

Each of the plurality of corrective constants z may be defined at a precision commensurate with the truncated summation array.

The plurality of corrective constants may comprise one or more of the following constants c:

$$For RTNI rounding , {Δ}_{low} + \frac{1}{q} > c \geq {Δ}_{high} ; \\ For RTPI rounding , {Δ}_{low} + 1 > c \geq {Δ}_{high} + \frac{q - 1}{q} ; \\ For RTU rounding , {Δ}_{low} + 1 - \frac{⌈ \frac{q}{2} ⌉ - 1}{q} > c \geq {Δ}_{high} + 1 - \frac{⌈ \frac{q}{2} ⌉}{q} .$$

The fixed logic circuit may further comprise one or more mode registers configurable at run time so as to indicate the rounding mode in which the truncated summation array is to operate, the selection logic being configured to select the respective corrective constant in dependence on the rounding mode indicated by the one or more mode registers.

The fixed logic circuit may further comprise correction logic configured to sum the selected corrective constant with the output of the truncated summation array to generate the output y.

The directed rounding mode may be one of: round towards zero; round towards negative infinity; round towards positive infinity; and round away from zero.

The round-to-nearest rounding mode may be one of: round to nearest, ties up; round to nearest, ties down; round to nearest, ties towards zero; round to nearest, ties away from zero; round to nearest, ties to even; and round to nearest, ties to odd.

There is provided a processor comprising the fixed logic circuit.

The fixed logic circuit may be embodied in hardware on an integrated circuit. There may be provided a method of manufacturing, at an integrated circuit manufacturing system, a fixed logic circuit. There may be provided an integrated circuit definition dataset that, when processed in an integrated circuit manufacturing system, configures the system to manufacture a fixed logic circuit. There may be provided a non-transitory computer readable storage medium having stored thereon a computer readable description of a fixed logic circuit that, when processed in an integrated circuit manufacturing system, causes the integrated circuit manufacturing system to manufacture an integrated circuit embodying a fixed logic circuit.

There may be provided an integrated circuit manufacturing system comprising: a non-transitory computer readable storage medium having stored thereon a computer readable description of the fixed logic circuit; a layout processing system configured to process the computer readable description so as to generate a circuit layout description of an integrated circuit embodying the fixed logic circuit; and an integrated circuit generation system configured to manufacture the fixed logic circuit according to the circuit layout description.

The above features may be combined as appropriate, as would be apparent to a skilled person, and may be combined with any of the aspects of the examples described herein.

### BRIEF DESCRIPTION OF THE DRAWINGS

Examples will now be described in detail with reference to the accompanying drawings in which:

FIG. 1 is a schematic representation of a binary array of addition operations for performing a multiply-add-shift operation.

FIG. 2 is a schematic diagram illustrating an additive CSD array for performing multiplication of an input x by a binary expansion of a rational p/q.

FIG. 3 illustrates identifying x_{high} and x_{low} for a simple array and a 5-bit input x.

FIG. 4 is a schematic diagram of a finite additive CSD array for approximately performing multiplication of an input x by a binary expansion of a rational p/q.

FIG. 5 is a flowchart illustrating a method of deriving a hardware representation of a binary logic circuit in accordance with the principles set out herein.

FIG. 6 is a schematic diagram of an exemplary hardware design system comprising a truncated array generator 602 that is configured to generate RTL defining a truncated array.

FIG. 7 shows an integrated circuit manufacturing system for generating an integrated circuit.

FIG. 8 illustrates the area and delay advantages of implementing multiplication by a constant fraction using a 16 nm process as a fixed logic circuit according to the principles taught herein.

FIG. 9 shows a fixed logic circuit for performing binary multiplication using a truncated addition array for a plurality of rounding modes.

The accompanying drawings illustrate various examples. The skilled person will appreciate that the illustrated element boundaries (e.g., boxes, groups of boxes, or other shapes) in the drawings represent one example of the boundaries. It may be that in some examples, one element may be designed as multiple elements or that multiple elements may be designed as one element. Common reference numerals are used throughout the figures, where appropriate, to indicate similar features.

### DETAILED DESCRIPTION

The following description is presented by way of example to enable a person skilled in the art to make and use the invention. The present invention is not limited to the embodiments described herein and various modifications to the disclosed embodiments will be apparent to those skilled in the art.

Embodiments will now be described by way of example only.

When modern integrated circuits (IC) designs are produced, these usually start with a high level design specification which defines the functionality required using a high level programming language that enables logical verification of the design. A register transfer level (RTL) model may then be synthesised (e.g. using commercially available tools) so as to produce a netlist of gates for implementation in silicon. The RTL model can be optimised to determine a preferred implementation of the design in silicon.

Multiplication of a variable x by a constant fraction p/q can be expressed as a multiply-add-shift operation. For example, with a round towards negative infinity (RTNI) or round towards zero (RTZ) scheme, the multiplication by a constant fraction operation can be expressed as the floor of a multiply-add-shift operation:

$$y = ⌊ \frac{px}{q} ⌋ = ⌊ \frac{ax + b}{{2}^{k}} ⌋ >> k \qquad ( 1 )$$

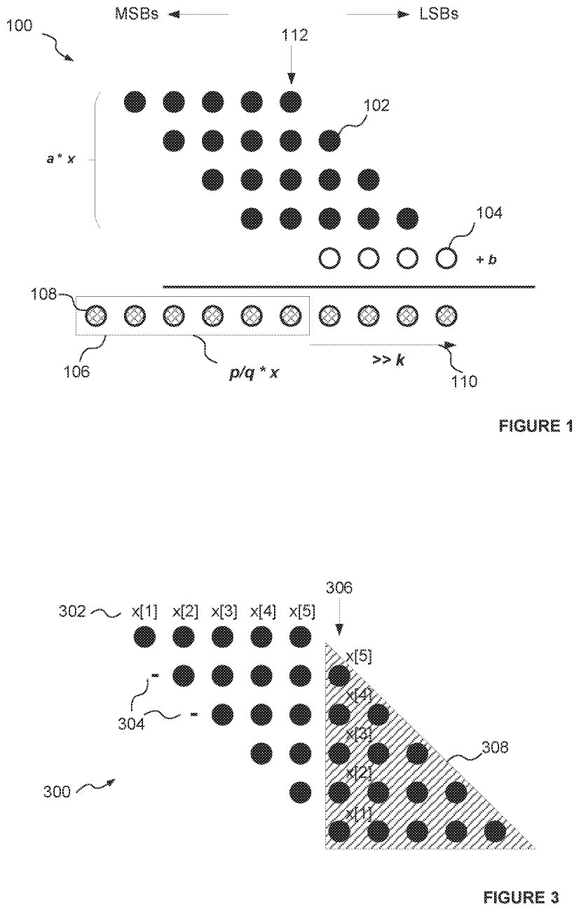

The rightmost notation indicates that the multiplication by a constant fraction operation reduces to a multiplication of the variable x by a constant a followed by an addition of a constant b, with the result right-shifted by k places. In other words, x is summed a times and constant b is added to the result, which is then shifted by k. This summation is illustrated as a binary array of addition operations 100 in FIG. 1 in which each filled circle 102 represents a bit of the variable x and each hollow circle 104 represents a bit of the constant b. The output 106 is right shifted k bits 110, with each hash-filled circle 108 representing a bit of the output y. The shape of the array of bits of x is a parallelogram formed from repeated rows of x offset relative to each other, where the maximum number of rows corresponds to the number of bits in a. The bits of x in each row are AND-ed with a corresponding bit of a (e.g. the top row is AND-ed with the MSB of a, and so on until the bottom row is AND-ed with the LSB of a). In this way, rows are skipped (or treated as all zeroes) where there is a 0 in the corresponding bit of a, and rows are included where there is a 1 in the corresponding bit of a. As such, the array may not be a smooth parallelogram shape (as shown in this example), but be more irregular due to some offsets being skipped due to 0 bits in a (as illustrated in later figures).

In the schematic representation shown in FIG. 1, the bits of the variables and constants are arranged in columns 112, with each column corresponding to a bit position in the output y. The most significant bits (MSBs) are on the left-hand side and the least significant bits (LSBs) are on the right hand side of the figure. The multiplication is calculated by summing all the bits of the array 100 and shifting the result.

An alternative to using the multiply-add-shift operation outlined above is to form an array from the full binary expansion of p/q, such that there is an array with one row of x for each bit value of 1 in the binary expansion of p/q (offset in the parallelogram form according to the location of the 1 in p/q). However, the binary expansion of p/q may be arbitrarily large or infinite, making such an array impractical to form in hardware.

However, where the precision of the sum of addends required is lower than that provided by a full summation, the array may be truncated so as to produce a less accurate result but one which can be achieved with a smaller binary logic circuit (or in the case of an infinite binary expansion, one that is implementable in practice). For example, one or more of the least significant columns multiplication array may be truncated (i.e. discarded). To compensate for this truncation a constant may be added to the multiplication result so as to achieve the required level of accuracy. Thus, truncation may comprise discarding some of the columns of the input bits and the adding of a constant to one or more of the remaining columns to provide an approximation to the true multiplication result. Synthesis of such an arrangement in RTL will result in a smaller netlist and will therefore enable a multiplier to be manufactured using fewer gates and thus less silicon. This will reduce the cost and consume less power.

An issue with truncating bits in sum of products operations is that it is complex to determine the effect of truncation and usually error statistics need to be gathered during RTL synthesis in order to achieve a desired accuracy. This is time consuming and can lead to many iterations being required during synthesis to produce just one multiplier unit. The complexity of synthesising truncated multiplier operations becomes worse as the size of the multiplication operation increases.

It is therefore desirable to be able to reduce the complexity of the synthesised logic as much as possible through truncation while maintaining a known error in the approximated result and without the time-consuming data manipulation being required to gather error statistics. Any reduction in complexity results in a reduction in silicon area and hence also in costs and power consumption. It is further desirable to be able to achieve true “directed rounding” (such as rounding towards or away from zero or towards positive or negative infinity) or “round-to-nearest” (such as rounding to nearest integer, with ties to even, odd, up or down) accuracy—such rounding schemes have an accuracy of at least ½ ULP (“unit in the last place” or “unit of least precision”). This can be contrasted with faithful rounding which is typically achieved through other approaches to calculating multiplication by an integer rational using truncated arrays, and provides an accuracy of at least 1 ULP. Table 1 below gives some examples of directed rounding and round to nearest schemes/modes, although it will be understood that this is not exhaustive and further schemes will be known to those skilled in the art.

TABLE 1

| Type | Acronym | Description |
|---|---|---|
| Directed | RTZ | Round towards zero |
| Directed | RTNI | Round towards negative infinity (also called “floor”) |
| Directed | RTPI | Round towards positive infinity (also called “ceiling”) |
| Directed | RAZ | Round away from zero |
| Round-to-nearest | RTU | Round to nearest, ties up |
| Round-to-nearest | RTD | Round to nearest, ties down |
| Round-to-nearest | RNTZ | Round to nearest, ties towards zero |
| Round-to-nearest | RNAZ | Round to nearest, ties away from zero |
| Round-to-nearest | RTE | Round to nearest, ties to even |
| Round-to-nearest | RTO | Round to nearest, ties to odd |

Described herein are methods for implementing multiplication by a constant fraction in hardware logic. The methods described reduce resource usage (e.g. area of hardware that is required) whilst providing a result to a desired level of accuracy according to a selected rounding scheme. Thus, the multiplication by an invariant rational is not evaluated to infinite precision but instead the methods allow multiplication by a constant fraction to be approximately performed.

Consider a signed m-bit integer input, x[m−1:0] which is to be multiplied by a constant fraction p/q. This operation can be expressed as:

$$y [ t - 1 : 0 ] = round ( \frac{p * x [ m - 1 : 0 ]}{q} ) \qquad ( 2 )$$

where p∈ [symbol] (an integer) and q∈ [symbol] (a natural number) where p, q are generic coprime constants, and t is some value where y[t−1:0] is a large enough signed number to represent all possible outputs given the input x. The value t is a function of m, p, q and the rounding mode, and so can be identified at design time according to any suitable method. Note that any rational value (a set denoted by the symbol [symbol] ) can be represented by these constraints on p, q.

The rounding mode could be, for example, any directed rounding or round-to-nearest scheme, such as those listed in Table 1. It will be apparent to those skilled in the art that the principles described herein can be applied to any rounding mode, where the rounding direction is independent of what two representable values the exact answer is located between. Similarly, it will be apparent that the principles described herein may be applied to unsigned inputs (and outputs).

It will be shown that the binary expansion of

$$\frac{p}{q} = \frac{1}{{2}^{i}} ( \frac{p}{{q}^{′}} ) = \frac{1}{{2}^{i}} ( B + \frac{p mod {q}^{′}}{{q}^{′}} ) \qquad ( 3 )$$

always takes the form of a concatenation of bits B with an infinite repeating sequence of bits A:
B A A A A . . .

Where B∈ [symbol] (an integer) and A∈ [symbol] ∪{0} (a natural number or zero) which is an infinitely repeating sequence. The expansion may be left padded with zeros so as to be width n (see below), with the binary point being located somewhere along the infinite expansion (including to the left of B).

In order to derive the binary expansion, we note that there will exist i such that q=2ⁱ\acute{q} where \acute{q} is odd (or, equivalently, coprime to 2). It follows that:

$$\frac{p}{q}$$

where

$$B = ⌊ \frac{p}{{q}^{′}} ⌋ ∈ ℤ and p mod {q}^{′} ∈ [ 0 , {q}^{′} - 1 ] , and so \frac{p mod {q}^{′}}{{q}^{′}} ∈ [ 0 , 1 ) .$$

Since \acute{q} is odd, there is a well-known result that says that there will exist n∈ [symbol] such that 2ⁿ−1 is an integer multiple of \acute{q}:

$$c {q}^{′} = {2}^{n} - 1 , and so \frac{p mod {q}^{′}}{{q}^{′}} = \frac{c ( p mod {q}^{′} )}{c {q}^{′}} = \frac{A}{{2}^{n} - 1} \qquad ( 4 )$$

Note that c(p mod \acute{q})=A∈(0,2^{k}−1) is an n bit unsigned integer since

$$\frac{p mod {q}^{′}}{{q}^{′}}$$

∈(0,1) is a purely fractional number, so

$$\frac{A}{{2}^{n} - 1}$$

represents each of the infinitely recurring blocks of length n in the binary expansion of

$$\frac{p}{q} .$$

In other words:

$$\frac{p}{q} = \frac{1}{{2}^{i}} ( B + \frac{A}{{2}^{n} - 1} ) \qquad ( 5 )$$

Typically, binary addition arrays for performing multiplication are configured to operate on binary numbers in their canonical signed digit (CSD) form. This is to reduce the number of rows in the final multiplication array. For example, considering the multiplication 15*x, the binary form of 15 is 1111, so multiplying by x involves an addition array with 4 rows, but instead expanding 15 in CSD form gives 1000S (where S here stands for −1). Using the CSD form of binary 15 in an addition array involves only 2 additions, where the row corresponding to S requires negating but, noting that −x=x̅+1, this can be cheaply achieved in hardware implementing the array by logically negating x followed by an increment.

In binary expansions there are only 2 states {0,1} (an S can be present if the binary value is a signed number, but only in the most significant bit) and in CSD form there are 3 states {S,0,1} where S represents −1. Any suitable algorithm may be used to convert binary numbers in to CSD form—these will be well known to the skilled person. Note that CSD forms always have at least one “0” on either side of a 1 or S, making them sparser expansions than binary expansions and hence suitable for building shallow (area/time saving) constant multiplication arrays. Their value can also very easily be negated by performing the swap 1↔S and they can be shown to be unique for any finite (terminating) binary expansion.

Converting an infinite binary expansion into CSD form can be more difficult because most algorithms start at the least significant bit of a binary number in order to derive its CSD form—for an infinite length binary expansion this is not possible.

A different approach is therefore needed to convert a binary expanded rational number into CSD form. An exemplary approach will now be described to derive a CSD expansion of the constant rational p/q, but in general any suitable approach could be used.

Consider the value

$$( \frac{A}{{2}^{n} - 1} )$$

from equation (5) above. This value can be written as:

$$( \frac{{2}^{n} - 1 - \overline{A}}{{2}^{n} - 1} ) = 1 + ( \frac{- \overline{A}}{{2}^{n} - 1} ) \qquad ( 6 )$$

where Ā=2ⁿ−1−A is the logical negation of the n-bit unsigned value A. At least one of the CSD expansions of A or −(̅A̅)̅ will give a valid CSD form for the infinite binary expansion as a whole. In order to be a valid CSD form, when repeated in the sequence B A A A . . . the CSD form of A or −(̅A̅)̅ must satisfy the requirement that there is at least one “0” on either side of a 1 or S. For example, 10050 could be a valid CSD form because when repeated there is at least one “0” on either side of a 1 or S: 100S0100S0100S0100S0 . . . . The same requirement needs to be satisfied at the boundary of the B and A values in the infinite binary expansion BAAAA . . . such that the CSD expansion as a whole represents a valid CSD form.

The CSD form of A shall be referred to as α=CSD (A) and the CSD form of −(̅A̅)̅ shall be referred to as β=CSD(−(̅A̅)̅). The CSD form of A can in some cases be selected in dependence on the value of A: if

$$A \leq ⌊ \frac{{2}^{n}}{3} ⌋$$

then pick α, if

$$A \geq ⌈ \frac{{2}^{n}}{3} ⌉$$

then pick β. Otherwise it may be checked to see which gives the correct CSD form. Where more than one possible CSD form exists, the form which gives a final addition array with the least number of rows should be selected at design time.

We now have that:

$$\frac{p}{q} = \frac{1}{{2}^{i}} ( B + \frac{A}{{2}^{n} - 1} ) = \{ \begin{matrix}\frac{1}{{2}^{i}} ( \frac{{2}^{n} B + A}{{2}^{n}} + \frac{1}{{2}^{n}} ( \frac{{α}_{+} - {α}_{-}}{{2}^{n} - 1} ) ) & if \frac{CSD ( A )}{{2}^{n} - 1} is a valid CSD form \\ \frac{1}{{2}^{i}} ( \frac{{2}^{n} ( B + 1 ) - \overline{A}}{{2}^{n}} + \frac{1}{{2}^{n}} ( \frac{{β}_{+} - {β}_{-}}{{2}^{n} - 1} ) ) & if \frac{- CSD ( \overline{A} )}{{2}^{n} - 1} is a valid CSD form\end{matrix} \qquad ( 7 )$$

where α=α₊−α₋ and α₊, α₋ are unsigned n bit binary integers which represent the values of the 1s and Ss (negative 1s) in the CSD expansion α. Similarly, β=β₊−β₋ and β₊, are unsigned n bit binary integers which represent the values of the 1s and Ss (negative 1s) in the CSD expansion β.

In order to represent the infinite binary expansion BAAAA . . . in a valid CSD form, the requirement that there is at least one “0” on either side of a 1 or S must be satisfied at the boundary of the B and A values in the expansion. This can be achieved by identifying the CSD form of: (i) in the case that

$$\frac{CSD ( A )}{{2}^{n} - 1}$$

is a valid CSD from, the finite binary number 2ⁿB+A; and (ii) in the case that

$$\frac{- CSD ( \overline{A} )}{{2}^{n} - 1}$$

is a valid CSD from, the binary number 2ⁿ(B+1)−Ā. In order to form a valid CSD expansion for the entirety of

$$\frac{p}{q} ,$$

the CSD form identified for 2ⁿB+A is concatenated with the infinitely recurring chain of a CSD values, or the CSD form identified for 2ⁿB+A is concatenated with the infinitely recurring chain of β CSD values. In other words, a valid CSD form for the entirety of

$$\frac{p}{q}$$

is given by:

$$\frac{p}{q} = \frac{1}{{2}^{i}} ( B + \frac{A}{{2}^{n} - 1} ) = \{ \begin{matrix}\frac{1}{{2}^{i + n}} ( {γ}_{+} - {γ}_{-} + ( \frac{{α}_{+} - {α}_{-}}{{2}^{n} - 1} ) ) & if \frac{CSD ( A )}{{2}^{n} - 1} is a valid CSD form \\ \frac{1}{{2}^{i + n}} ( {δ}_{+} - {δ}_{-} + ( \frac{{β}_{+} - {β}_{-}}{{2}^{n} - 1} ) ) & if \frac{- CSD ( \overline{A} )}{{2}^{n} - 1} is a valid CSD form\end{matrix} \qquad ( 8 )$$

where CSD(2ⁿB+A):=γ:=γ₊−γ₋ and CSD(2ⁿ(B+1)−Ā):=δ:=δ₊−δ₋.

In summary, there exists a not necessarily unique CSD expansion of any rational number

$$\frac{p}{q}$$

∈ [symbol] which has the form:

$$\frac{p}{q} = \frac{1}{{2}^{i + n}} ( {ρ}_{+} - {ρ}_{-} + ( \frac{{θ}_{+} - {θ}_{-}}{{2}^{n} - 1} ) ) := {Σμ}_{i} {2}^{i} \qquad ( 9 )$$

where μᵢ∈{−1,0,1}, each 1 and −1 value is adjacent to at least one 0, and ρ_{±}, θ_{±}, i, n, L∈ [symbol] ∪{0} can all be derived from p, q, where L is the length of ρ and n is the length of θ. The CSD form of the binary expansion BAAAA . . . can therefore be written as form of a concatenation of bits ρ with an infinite repeating sequence of bits θ:
ρ θ θ θ θ . . .
   where the binary point is i+n bits to the left of the left of the boundary between ρ and θ.

It should be noted that the signed m-bit integer input x[m−1:0] can be written as x=−2^{m-1}+\acute{x}, where \acute{x} is an unsigned m-bit integer. This observation enables all bits in \acute{x}[m−1:0] to be handled in the same manner as unsigned bits ({0,1}) instead of there being a ‘differently interpreted’ sign bit as the most significant bit. Using this observation, the multiplication by a rational

$$\frac{p}{q} * x [ m - 1 : 0 ]$$

can be written as follows:

$$y = \frac{p}{q} * x [ m - 1 : 0 ] = \frac{1}{{2}^{i + n}} ( {ρ}_{+} - {ρ}_{-} + ( \frac{{θ}_{+} - {θ}_{-}}{{2}^{n} - 1} ) ) * ( - {2}^{m - 1} + {x}^{′} ) = - \frac{{2}^{m - 1} p}{q} + \frac{1}{{2}^{i + n}} ( {ρ}_{+} * {x}^{′} + ( \frac{{θ}_{+}}{{2}^{n} - 1} ) * {x}^{′} + {ρ}_{-} * ( - {x}^{′} ) + ( \frac{{θ}_{-}}{{2}^{n} - 1} ) * ( - {x}^{′} ) ) = - \frac{{2}^{m - 1} p}{q} + \frac{1}{{2}^{i + n}} ( {ρ}_{+} * {x}^{′} + ( \frac{{θ}_{+}}{{2}^{n} - 1} ) * {x}^{′} + {ρ}_{-} * ( \overline{{x}^{′}} - {2}^{n} + 1 ) + ( \frac{{θ}_{-}}{{2}^{n} - 1} ) * ( \overline{{x}^{′}} - {2}^{m} + 1 ) ) = - \frac{{2}^{m - 1} p}{q} - \frac{1}{{2}^{i + n}} ( {ρ}_{-} * ( {2}^{m} - 1 ) + ( \frac{{θ}_{-}}{{2}^{n} - 1} ) * {x}^{′} + {ρ}_{-} * \overline{{x}^{′}} + ( \frac{{θ}_{-}}{{2}^{n} - 1} ) * \overline{{x}^{′}} ) = {x}^{′} * \frac{1}{{2}^{i + n}} ( {ρ}_{+} + ( \frac{{θ}_{+}}{{2}^{n} - 1} ) ) + \overline{{x}^{′}} * \frac{1}{{2}^{i + n}} ( {ρ}_{-} + ( \frac{{θ}_{-}}{{2}^{n} - 1} ) ) + τ \qquad ( 10 )$$

$$where τ = - ( \frac{{2}^{m - 1} p}{q} + \frac{( {2}^{m} - 1 )}{{2}^{i + n}} ( {ρ}_{-} + ( \frac{{θ}_{-}}{{2}^{n} - 1} ) ) ) ∈ ℚ$$

and \acute{x}=x̅[̅m̅−̅1̅]̅|x[m−2:0] (i.e a concatenation of bits x̅[̅m̅−̅1̅]̅ with x[m−2:0]) and \acute{x̅}=x[m−1]|x̅[̅m̅−̅2̅:̅0̅]̅ (i.e a concatenation of bits x[m−1] with x̅[̅m̅−̅2̅:̅0̅]̅)

\acute{x} and \acute{x̅} are both unsigned m bit integer values and multiplied by positive values, so every partial product bit in the array can be treated as 0 or a positive 1. In other words, all the sign-bit extension/negative value complication has been shifted into the value of the constant τ.

### Truncated Array

Methods will now be described to derive fixed logic hardware comprising an addition array configured to operate on CSD forms of binary values (a CSD array) so as to form an approximation of a multiplication of an input x[m−1:0] by a rational

$$\frac{p}{q} .$$

It will be appreciated that the principles described herein may be applied to arbitrary binary addition operations so as to derive an additive array configured to form a CSD array for performing an approximation of the binary addition operations.

As has been demonstrated, in its general form, an additive array for performing multiplication by a binary expansion of a rational p/q would be infinite in size because the binary expansion of the rational p/q for non-trivial cases is infinite in length. In order to render such an array implementable in hardware, it is necessary to form an array which is finite in size—i.e. an array arranged to sum a finite number of partial product bits. A finite array would, in general, calculate an approximation to the true result of the multiplication operation. However, it is possible to truncate the infinite array and correct the approximation through the addition of a constant in a manner which satisfies a required accuracy according to a defined rounding scheme.

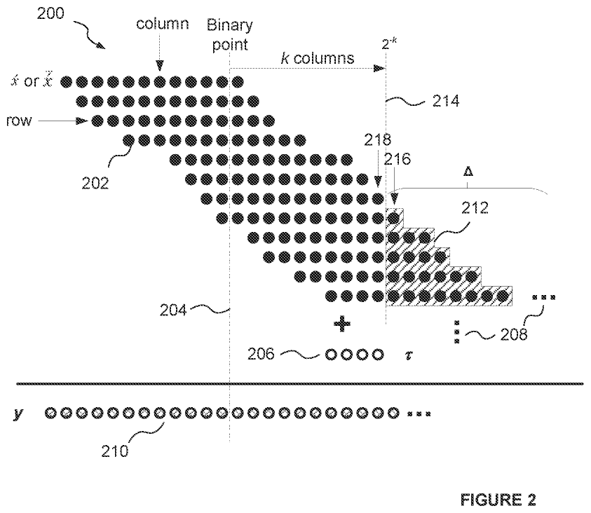

FIG. 2 is a schematic diagram illustrating an additive CSD array 200 for performing multiplication of an input x by a binary expansion of a rational p/q. The bits 202 of each row of the array comprise \acute{x} or \acute{x̅} as set out in equation (10) above. This is because performing the multiplication

$$\frac{p}{q} * x$$

comprises summing

$$x \frac{p}{q}$$

time. For non-trivial cases, the binary expansion of p/q is infinite in length and therefore the array is infinite in size, as indicated by 208. In this example, x is represented in its CSD forms (representing unsigned \acute{x} or \acute{x̅}) but more generally the array could be configured to operate on x or any suitable derivative of x expressed in any suitable form. The array comprises a binary point 204 with respect to which the values of \acute{x} and \acute{x̅} are arranged. The array 200 further comprises addition of a constant τ 206 so as to form an exact output y 210. The constant τ and/or output y may themselves be infinitely long.

In order to derive an array which is finite in size and may therefore be implemented in hardware, the array may be truncated by removing an infinite set of least significant bits Δ of the array of bits of \acute{x} and \acute{x̅} (shaded area 212 in the figure, not including bits of constant τ). Such a finite array will generate an approximate result. Methods will now be described to programmatically derive a finite size array for calculating an output to a required level of accuracy whilst achieving directed rounding or round-to-nearest rounding. Such methods can be used to determine a fixed size array having an accuracy sufficient for implementation in fixed logic hardware operating to a predefined precision.

The infinite set of least significant bits Δ represents a set of partial product bits (except those of the constant τ) whose sum is equal to Δ(x). The set of bits Δ depends on x because this sum is a function of the input bits x[m−1:0] (and their logical negations). Δ(x) can be expected to fall between upper and lower bounds Δ_{high} and Δ_{low}, where Δ_{high}≥Δ_{low}≥0 because all the bits are unsigned.

Recall that whilst p and q are known at design time, the input x is not. The array must be configured to operate to the desired level of accuracy for all possible inputs x. For a given removed set of bits Δ, the upper and lower bounds Δ_{high} and Δ_{low} can be identified by considering possible values of the most significant bits in the removed set. In other words, identify inputs x_{high} and x_{low} such that Δ(x_{high})=Δ_{high} and Δ(x_{low})=Δ_{low}. This is because the most significant bits of the removed set necessarily have a higher value than the sum of all of the less significant bits in any array shape.

Noting that there cannot be two bits of x with the same index in the same column (due to the array being made up of copies of \acute{x} and \acute{x̅} in differing positions) and that each bit at the same bit position in x must be the same value throughout the array, it is possible to identify Δ_{high} and Δ_{low} by considering the most significant bits removed from the array (e.g. in the truncation at column 216 in FIG. 2, all those bits in column 216 and in less significant columns) and applying the following rules:
i. identify the most significant instance of each bit of x (i.e. each x[i]) in the bits removed from the array;
ii. to find x_{high} set each of the most significant instances of the bits of x to 1 if in a non-negated row, and each bit of x to zero if in a negated row (recall that the array operates on the CSD form of x and for simplicity referring to the bits of \acute{x} and \acute{x̅} as bits of x), i.e. set x[i]=1 and x̅[̅i̅]̅=0;
iii. x_{low} is then the logical negation of x_{high} as an m-bit string, i.e. x_{low}=x̅_̅{̅h̅i̅g̅h̅}̅.

In this manner all of the bits of x_{high} and x_{low} can be identified and hence the infinite set of bits Δ_{high} and Δ_{low} are known. Note that if, unusually, an i^{th} bit of x doesn't occur in the removed group then that particular x[i] has no effect on Δ(x) and can be set to zero. It will be appreciated that, equivalently, x_{high} could be derived from x_{low}, or both x_{high} and x_{low} could both be independently determined. In general any suitable algorithm could be used to identify Δ_{high} and Δ_{low}.

An example of identifying x_{high} and x_{low} is illustrated in FIG. 3 for a simple array 300 and a 5-bit input x. Each of the five bits of x is identified by the labels 302 x[1] through to x[5]. Some of the rows of the array comprise x in its negated form as indicated by negations 304. Consider truncating the array by removing bits 308. In this example, all of the most significant instances of the bits of x are in column 306 of the removed bits (which is the most significant column of the removed bits). In other words, column 306 in this example contains each of bits x[1] through to x[5]. It follows from applying steps (i)-(iii) above that, in binary, x_{high}=11100 and therefore x_{low}=00011 in this example (x_{high} formed from x[1], x[2] & x[3] in non-negated rows and x̅[̅4̅]̅ & x̅[̅5̅]̅ from negated rows, and x_{low} formed as x̅_̅{̅h̅i̅g̅h̅}̅, i.e. as x̅[̅1̅]̅ x̅[̅2̅]̅ x̅[̅3̅]̅ x[4] x[5]). In other examples, the most significant instances of the bits of x may not be located in a single column and further examples may also use more complex forms of truncation which may further cause the most significant instances of the bits of x to be located over more than one column (e.g. ragged truncation as described below).

The value of Δ(x)∈ [symbol] is straightforward to calculate at design time since it's the difference between an exact answer

$$\frac{p}{q} * x$$

(where x is again treated as a signed m-bit value) and the sum of finite values of the CSD array including the value of r (which may be infinite but well defined), which can be denoted as

$${( \frac{p}{q} * x )}_{finite} .$$

in other words:

$$\frac{p}{q} * x - {( \frac{p}{q} * x )}_{finite} = Δ ( x ) \qquad ( 11 a )$$

And so, once x_{high} and x_{low} have been identified, only two calculations are required to find Δ_{high} and Δ_{low} such that for all x, Δ(x)∈[Δ_{low}, Δ_{high}]:

$$\begin{matrix}\frac{p}{q} * {x}_{high} - {( \frac{p}{q} * {x}_{high} )}_{finite} = Δ ( {x}_{high} ) = {Δ}_{high} & ( 11 b ) \\ \frac{p}{q} * {x}_{low} - {( \frac{p}{q} * {x}_{low} )}_{finite} = Δ ( {x}_{low} ) = {Δ}_{low} & ( 11 c )\end{matrix}$$

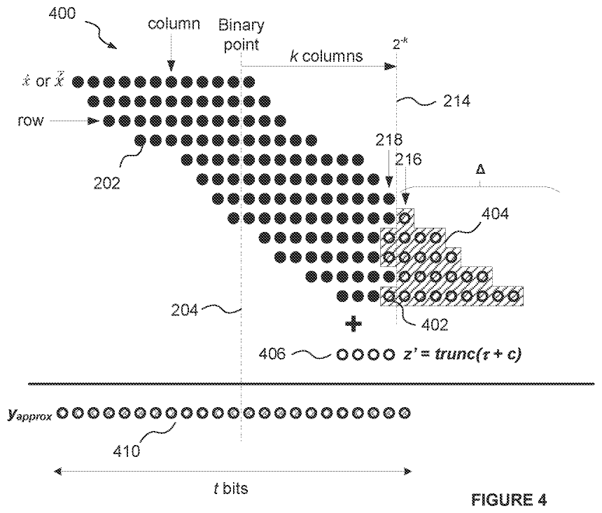

On removing bits from the array it is advantageous to modify the constant τ so as to compensate in the addition array for the loss of those bits. FIG. 4 is a schematic diagram of a finite additive CSD array 400 for approximately performing multiplication of an input x by a binary expansion of a rational p/q so as to generate yₐₚₚᵣₒₓ 410. Hashed bits 404 do not form part of the array and are included for illustrative purposes only. The removed bits 404 may include, in addition to bits Δ, further bits 402 as a result of a ragged truncation which is discussed below. The effect of removing bits 404 from the array is compensated for in part by adding a constant c to the constant τ identified in equation (10) so as to form a new additive constant z—e.g. as shown in its truncated form z′ 406 in FIG. 4.

It is not possible for constant c to perfectly compensate for the loss of the removed bits 404 over all possible inputs x. It is advantageous if the constant c enables the approximation to be as close as possible to the true result over all inputs x. One way of achieving this is to ensure that the integer value of the output is unchanged to the accuracy required when the constant c=τ−Δ_{high} or τ−Δ_{low} (i.e. the two extremes of c). In other words, that the following is true for all c:

$${y}_{approx} [ t - 1 : 0 ] = round ( \frac{p}{q} * x ) = ⌊ {( \frac{p}{q} * x )}_{finite} + c ⌋ \qquad ( 11 d )$$

Where

$${( \frac{p}{q} * x )}_{finite}$$

refers to the calculation performed by the finite CSD array on the bits of x (i.e. not including the addition with c).

Heuristics for identifying sets of partial product bits of x[i] and x̅[̅j̅]̅ which can be removed and replaced by a corrective constant c, whilst maintaining the accuracy demanded by the rounding for calculating y[t−1:0], will now be described. These approaches enable a finite size array to be identified which can be implemented in hardware as a fast and small additive array.

As examples, we consider three rounding cases: RTNI (round to negative infinity), RTPI (round to positive infinity), and RTU (round to nearest, tie round up). A rounding point of a rounding mode is defined to be the point, either side of which the infinitely precise solution will jump to a different consecutive representable number.

### RTNI

The rounding points for RTNI rounding are the integers. Let rₐ be the smallest distance above or equal to an integer that a value of

$$\frac{p}{q} * x [ m - 1 : 0 ]$$

can take. This is zero, since x=0 implies that

$$\frac{p}{q} * x = 0 ∈ ℤ .$$

Let r_{b} be the smallest distance strictly below or equal to an integer that a value of

$$x ∈ \frac{p}{q} * x [ m - 1 : 0 ]$$

can take. This will be

$$\frac{1}{q}$$

as there will typically exist a value of [−2^{m-1},2^{m-1}−1] where (p*x)mod q=q−1, provided that 2^{m}>q. In order to ensure that the removed bits do not change the integer output of the finite array, we require that:

rₐ−Δ_{low}+c<1

rₐ−Δ_{high}+c≥0

−r_{b}−Δ_{low}+c<0

−r_{b}−Δ_{high}+c≥−1 (12)

It is clear from the definitions of rₐ and r_{b} that rₐ+r_{b}≤1. Using this fact with a suitable pair of inequalities (12) gives:

Δ_{low}+r_{b}>c≥Δ_{high}−rₐ (13)

So for a value of c∈ [symbol] to exist, we must have: r_{b}+rₐ>Δ_{high}−Δ_{low}. Substituting the values identified above of

$${r}_{b} = \frac{1}{q}$$

rₐ=0 gives:

$$\frac{1}{q} > {Δ}_{high} - {Δ}_{low} \qquad ( 14 )$$

And so the bounds on constant c are:

$${Δ}_{low} + \frac{1}{q} > c \geq {Δ}_{high} \qquad ( 15 )$$

### RTPI

The rounding points for RTPI rounding are the integers. rₐ and r_{b} are swapped with respect to the RTNI case such that

$${r}_{a} = \frac{1}{q}$$

and r_{b}=0. In order to ensure that the removed bits do not change the integer output of the finite array, we require that:

rₐ−Δ_{low}+c<2

rₐ−Δ_{high}+c≥1

−r_{b}−Δ_{low}+c<1

−r_{b}−Δ_{high}+c≥0 (16)

It is clear from the definitions of rₐ and r_{b} that rₐ+r_{b}≤1. Using this fact with a suitable pair of inequalities (16) gives:

Δ_{low}+r_{b}+1>c≥Δ_{high}−rₐ+1 (17)

So for a value of c∈ [symbol] to exist, we must have: r_{b}+rₐ>Δ_{high}−Δ_{low}. Substituting the values identified above of

$${r}_{a} = \frac{1}{q}$$

and r_{b}=0 gives:

$$\frac{1}{q} > {Δ}_{high} - {Δ}_{low} \qquad ( 18 )$$

And so the bounds on constant c are:

$${Δ}_{l o w} + 1 > c \geq {Δ}_{h i g h} + \frac{q - 1}{q} \qquad ( 19 )$$

### RTU

The rounding points for RTU rounding are the exact halfway points between the integers. Let rₐ be the smallest distance above or equal to an integer halfway point that a value of

$$\frac{p}{q} * x [ m - 1 : 0 ]$$

can take. This will be

$$\frac{⌈ \frac{q}{2} ⌉}{q} - \frac{1}{2}$$

since there will be a value of x such that

$$( p * x ) mod q = ⌈ \frac{q}{2} ⌉ ,$$

provided that q>2^{m} (however, for unusual use cases/arbitrary arrays this may be different).

Let r_{b} be the smallest distance strictly below an integer halfway point that a value of

$$\frac{p}{q} * x [ m - 1 : 0 ]$$

can take. This will be

$$\frac{1}{2} - \frac{⌈ \frac{q}{2} ⌉ - 1}{q}$$

since there will be a value of x such that

$$( p * x ) mod q = ⌈ \frac{q}{2} ⌉ - 1$$

provided that q>2^{m}. In order to ensure that the removed bits do not change the integer output of the finite array, we require that:

rₐ−Δ_{low}+c<—3/2

rₐ−Δ_{high}+c≥½

−r_{b}−Δ_{low}+c<½

−r_{b}−Δ_{high}+c≥−½ (20)

It is clear from the definitions of rₐ and r_{b} that rₐ+r_{b}≤1. Using this fact with a suitable pair of inequalities (20) gives:

Δ_{low}+r_{b}+½>c≥Δ_{high}−rₐ+½ (21)

So for a value of c∈ [symbol] to exist, we must have: r_{b}+rₐ>Δ_{high}−Δ_{low}. Substituting the values identified above of

$${r}_{b} = \frac{1}{2} - \frac{⌈ \frac{q}{2} ⌉ - 1}{q} and {r}_{a} = \frac{⌈ \frac{q}{2} ⌉}{q} - \frac{1}{2}$$

gives:

$$\frac{1}{q} > {Δ}_{high} - {Δ}_{low} \qquad ( 22 )$$

$${Δ}_{low} + 1 - \frac{⌈ \frac{q}{2} ⌉ - 1}{q} > c \geq {Δ}_{high} + 1 - \frac{⌈ \frac{q}{2} ⌉}{q} \qquad ( 23 )$$

For a given truncation we can therefore determine suitable values for the constant c for each of the rounding modes RTNI, RTPI and RTU. Based on the approach described above, it will be apparent to the skilled person that suitable values of c can be similarly derived for other rounding modes.

For arbitrary type of arrays, it is generally necessary to conservatively assume that rₐ, r_{b}≈0 because the values of rₐ and r_{b} are not known. This means that 0˜>Δ_{high}−Δ_{low}. But since Δ must be a constant for all inputs in a fixed logic array, then Δ=0 for all inputs and no truncation can occur. This is because in an arbitrary array, it is not known how far a carry bit can propagate. For

$$\frac{p * x [ m - 1 : 0 ]}{q}$$

we have established that

$${r}_{b} + {r}_{a} \geq \frac{1}{q} > 0$$

and this allows truncation with a constant correction to be possible, whilst maintaining a 0.5 ULP rounding accuracy (e.g. as offered by the RTNI, RTPI, RTU rounding schemes).

### Efficient Truncation

In order to determine a value for the constant c and to establish the accuracy of a given truncation, it is necessary to identify a suitable truncation of the least significant bits of x. Various approaches may be used at design time to establish a suitable truncation of an array, including trying to guess (e.g. based on experience of the user) or by starting the search for a suitable column at or close to the most significant columns of the array and exhaustively testing each column in the direction of the least significant columns until a truncation is identified which provides the desired accuracy whilst minimising the size of the array.

Provided here is a heuristic approach for identifying a suitable column at which to perform truncation—at least as an initial guess as to an appropriate truncation point. Further refinement of the truncation may be performed. The following method can be readily implemented in synthesis tools for generating fixed logic hardware for performing multiplications by a constant rational.

Consider retaining k columns below the position of the binary point, as indicated in FIGS. 2 and 4, and removing all less significant columns—i.e. those to the right of line 214 in the figures. It follows from the definitions above that the value of Δ_{low} has a lower bound of 0 since all bits are unsigned. The maximum value of Δ_{high} must be less than m2^{-k}, since we cannot have more than one of a given bit position x[i] of the input x in the same column (since the array is a CSD array) and there are m of these for an input x of bit length m. If all columns at least k+1 bit positions below the binary point (i.e. column 216 in FIGS. 2 and 4 and all columns to the right of it) comprised all 1s, then the sum of the bits of those columns would be m2^{-k}. It therefore follows that:

m2^{-k}≥Δ_{high}−Δ_{low} (24)

From equations (14), (18) and (22) above, it follows that:

$$m {2}^{- k} < \frac{1}{q} \qquad ( 26 )$$

A good candidate column at which to perform truncation of the array is therefore to truncate the k^{th} column below the position of the binary point and all columns which are less significant than the k^{th} column, where k is a positive integer large enough such that:

k=└ ln₂(mq)┘+1 (26)

### Ragged Truncation

Simply truncating at a column is typically not the optimal solution in terms of the size of the array and it is possible to remove further bits of the array without affecting its accuracy.

Consideration of the three rounding modes discussed above has identified the same general relation:

$$\frac{1}{q} > {Δ}_{high} - {Δ}_{low} \qquad ( 28 )$$

with the difference between the rounding modes being in the conditions on the correctional constant c.

The smallest addition array for performing multiplication by a constant rational can be identified by removing a set of partial products bits such that the smallest finite amount remain which satisfies inequality (28). Implementing such an addition array in fixed logic hardware minimises the size of the hardware and its delay.

A heuristic has been provided to identify a starting column at which to truncate the array. In some edge cases, this heuristic may not identify the optimal column and so subsequently—or as an alternative to the heuristic—the array may be truncated by removing the least significant columns of the array until there comes a point where, on evaluating Δ_{high} and Δ_{low} in respect of the truncation,

$$\frac{1}{q} \geq {Δ}_{high} - {Δ}_{low} .$$

When this inequality is not satisfied for a given column, that column is to be retained in the array and truncation is performed starting at the adjacent less significant column such that

$$\frac{1}{q} > {Δ}_{high} - {Δ}_{low}$$

is satisfied.

It is generally possible to refine the truncation of the array at a column by removing individual partial product bits from the least significant column left in the array. For example, in FIG. 4, column 218 is the least significant column left in the array and further bits 402 may be removed so as to further reduce the size of the array. This may be termed ragged truncation. Any suitable method for performing a bit-wise (or multiple bits at a time) reduction in the size of an array may be used.

In order to optimise the size of the array, it is advantageous to minimise the growth in Δ_{high}−Δ_{low} as bits are removed. This can be achieved by:
i. removing those i^{th} bits of x in the least significant column remaining in the array (e.g. 218) which have a different logical negation to the most significant i^{th} bit of x in the removed set of bits (404); and
ii. choosing that i^{th} bit of x in the least significant column remaining in the array which, when removed from the array, causes the greatest difference in Δ_{high}−Δ_{low}.

This process can be repeated whilst

$$\frac{1}{q} > {Δ}_{high} - {Δ}_{low}$$

is satisfied, with the optimal truncation being the case when the least partial products remain in the finite array with this inequality still being satisfied. It may be possible to repeat this process until all the index values of x in the least significant column remaining in the array have the same logical negation as their respective most significant index members in the removed set of partial product bits—in this case the value of Δ_{high}−Δ_{low} will grow by 2^{-j} where j is the number of bits in the least significant column remaining in the array.

If there are equivalent choices in which bit to remove at each point, a sensible choice would be to remove the bit with the index of x which occurs most frequently in the set of bits in the finite array so as to reduce fan-out on the input x in a hardware implementation of the array. This typically means (assuming all bits would have equal delay in a hardware implementation of the array) removing bits with higher index values (more significant in x) before lower index ones.

The ragged truncation process may start from the candidate column identified by equation (26). Ragged truncation is performed stepwise but may be automated such that it can be performed by synthesis tools configured to generate fixed logic hardware from a definition of an array.

### Optimisations on the Constant

At design time, once a finite CSD array has been identified (e.g. after performing efficient truncation followed by ragged truncation) such that

$$\frac{1}{q} > {Δ}_{high} - {Δ}_{low}$$

and the size of the array has been reduced, the value of c can be calculated according to the rounding mode to be used—e.g. using equations (15), (19) or (23) above. By combining c with the value of τ identified above at equation (10) yields an additive constant z=τ+c∈ [symbol] (which, as described below, may be truncated as z′ after the least significant column retained in the array). Thus z may be calculated as a function of the rounding mode, the known constants m, p, q, and the signage of x. The constant z may be an unsigned or signed fixed point value which can be sign-extended accordingly such that the correct value for the following is output:

$$y [ t - 1 : 0 ] = round ( \frac{p * x [ m - 1 : 0 ]}{q} ) \qquad ( 29 )$$

The constant z is included in the finite size array of addition operations so as to provide a hardware implementable array of minimal size and delay for the desired level of accuracy and rounding mode.

In some cases, the length of constant z may be such that the bits of z extend beyond the column at which truncation is performed—e.g. in FIG. 4, beyond column 218 into less significant columns. In some case, z could be infinite in length. Constant z may be truncated at the same column at which truncation is performed for sets of bits of x so as to form a truncated constant z′—i.e. by removing all bits of z in columns less significant than column 218. All of the least significant bits of the unsigned or signed constant z are positive and so their value has no effect on the value of the output y[t−1:0]. Hence, including constant z′ in the finite CSD array in place of constant z gives the same correct value for y[t−1:0] whilst maintaining a finite and compact array.

In some examples, the hardware may be implemented such the value of the constant c is selectable in the array at run time from a plurality of values so as to enable the array to perform multiplication of an input x by a constant rational according to any one of a plurality of different rounding modes. The appropriate rounding mode may be selected at run time through appropriate configuration of one or more registers of an integrated circuit at which fixed logic circuit implementing the multiplication is provided. For example, by appropriately setting one or more registers, gates of a fixed logic circuit could be configured such that certain logic paths are enabled and others are disabled so as to cause the fixed logic circuit to be configured to perform summation including different values of the corrective constant, as appropriate to the particular rounding mode.

FIG. 9 shows an exemplary fixed logic circuit 900 for performing binary multiplication using a truncated addition array 902 for a plurality of rounding modes. The fixed logic circuit includes registers 906 which define a plurality of corrective constants. The corrective constants defined in the registers may be a corrective constant z as defined herein for addition with the output of the summation array or, in some examples, a corrective constant c as defined herein (where z=c+τ), with the constant τ being handled in the truncated addition array or as an addition to the output of the array. Typically the constant c or z will be stored in a truncated form to a precision commensurate with the precision of the truncated addition array. As has been described, the corrective constant c required to ensure that the fixed logic circuit provides the correct output y 912 for a given input x 910 will depend on the rounding mode.

Each corrective constant may be defined in the registers in any suitable manner. For example, the registers may define a corrective constant as a configuration of gates in the fixed logic circuit or a set of values for summation with the output of the array. Correction logic 908 is configured to effect a corrective constant defined in the registers. Selection logic 904 is provided to select the appropriate corrective constant from the registers 906 according to the rounding mode 914 in which the fixed logic circuit is to operate.

In a first example, the registers 906 define a configuration of gates in the fixed logic circuit—represented by correction logic 908—which will cause the truncated array to add the appropriate corrective constant to the addition operation for the rounding mode 914. For instance, gates of the correction logic 908 could be configured such that certain logic paths in the fixed logic circuit are enabled and others are disabled so as to cause the addition of a corrective constant appropriate to the particular rounding mode. On selecting a corrective constant at the registers, the selection logic may effect the corrective constant by causing the gates of the correction logic to be configured in accordance with the definition of the corrective constant at the registers. Note that corrective constants need not be explicitly held at the registers; the registers may define in any suitable manner configurations of the gates of the correction logic corresponding to the corrective constants, e.g. the registers may hold binary values for each corrective constant representing the gate states necessary to effect each corrective constant.

In a second example, the registers 906 hold a representation of the corrective constant and the correction logic 908 comprises a set of configurable registers arranged for addition with the output of the truncated summation array 902. On selecting a corrective constant at the registers, the selection logic is configured to read into the configurable registers the values held at the registers which represent the selected corrective constant. In this manner the fixed logic circuit can be arranged to add the appropriate corrective constant to the output of the truncated summation array.

The registers 906 may include one or more configurable mode registers identifying the rounding mode in which the fixed logic circuit is to operate. For example, at runtime the mode registers may be set in accordance with a selected rounding mode—e.g. by firmware, a software driver or other entity configured to make perform calculations using the fixed logic circuit. The selection logic 904 may be configured to read the mode registers and, in dependence on the rounding mode identified therein, select the corresponding corrective constant defined at the registers and cause that corrective constant to be effected in the correction logic 908.

In some examples, the corrective logic may be part of the truncated summation array 902.

Assuming the least significant column of the finite array has weight 2^{-k} this means that with the maximum amount of truncation we can guarantee that

$$\frac{1}{q} > {Δ}_{high} - {Δ}_{low} \geq \frac{1}{q} - {2}^{- k} .$$

If not, then we could simply remove another bit from the 2^{-k} column and still have

$$\frac{1}{q} > {Δ}_{high} - {Δ}_{low} ,$$

which shows the maximum number of bits was not truncated, contradicting our assumption. This lower bound on Δ_{high}−Δ_{low}, implies upper and lower bounds on c (for each considered rounding mode), hence also on z′ such that 0<z′ₘₐₓ−z′ₘᵢₙ≤2^{-k}, consequently meaning that z′ is either unique or can take the value of 2 consecutive multiples of 2^{-k}.

If there are 2 values of z′, choosing the larger zₘₐₓ will allow one extra bit from the 2^{-k} row to be removed (this can be seen by remembering that the smaller value of z′ₘₐₓ−1 also gives an accurate value for y for all inputs x). In unusual cases, if z′ₘₐₓ ends in a 0 and only one more bit remains in column 2^{-k}, this can then also be removed, as it cannot generate a carry which affects the output y.

In summary, typically, if z′ is unique, no further bits can be removed but if it can take 2 values, taking the z′ₘₐₓ value means that one more bit can be removed from the 2^{-k} column, making the final value z′=z′ₘₐₓ unique.

In comparison to other multiply-add-shift approaches to generating arrays, the methods described herein for generating fixed size arrays in hardware for performing multiplication by a rational constant that achieve directed rounding or round-to-nearest rounding offer better performance (smaller size and lower latency) as the recurring length of

$$\frac{p}{q}$$

increases and the size of m (length of input x) increases.

It will be appreciated that the methods described herein could be extended to calculate a result for the general multiplication operation:

y[t−1:0]=ROUND(Σᵢ₌₁^{k}αᵢ*xᵢ[mᵢ−1]+β) (30)

where αᵢ, β∈ [symbol] and the xᵢ are independent inputs of differing sizes and signages and ROUND is, for example, any of RTU (round to nearest, tie round up), RTNI (round to negative infinity), or RTPI (round to positive infinity).

### Example

An example of the application of the methods described herein will now be described for the case m=16, p=84, q=108, where x is an unsigned integer input and the rounding mode RTNI is used (and noting that p, q are not yet in coprime form).

$$y [ 15 : 0 ] = RTNI ( \frac{84 * x [ 15 : 0 ]}{108} ) \qquad ( 31 )$$

By inspection (or using a highest common factor calculating algorithm, such as Euler's algorithm), it can be seen that

$$\frac{84}{108} = \frac{12}{12} * \frac{7}{9} = \frac{7}{9}$$

where 7 & 9 are co-prime. Using the multiply-add-shift algorithm in equation (1) above, gives y[15:0]=(101945*x[15:0])>>17 (there is freedom in the additive constant b∈[0,7281], but using the value 0 requires the smallest number of bits and hence would yield the smallest hardware). In binary, the CSD form of 101945 is 10S00100S00100S001, and so the multiply-add-shift calculation in CSD form can be expressed as:

$$\begin{matrix}y [ 15 : 0 ] = ( ( x [ 15 : 0 ] ≪ 17 ) + ( x [ 15 : 0 ] ≪ 12 ) + ( x [ 15 : 0 ] ≪ 6 ) + x [ 15 : 0 ] - \\ ( ( x [ 15 : 0 ] ≪ 15 ) + ( x [ 15 : 0 ] ≪ 9 ) + ( x [ 15 : 0 ] ≪ 3 ) ) ) ≫ 17 \\ = ( ( x [ 15 : 0 ] ≪ 17 ) + ( x [ 15 : 0 ] ≪ 12 ) + ( x [ 15 : 0 ] ≪ 6 ) + x [ 15 : 0 ] + \\ ( \overline{x [ 15 : 0 ]} ≪ 15 ) + ( \overline{x [ 15 : 0 ]} ≪ 9 ) + ( \overline{x [ 15 : 0 ]} ≪ 3 ) - {2}^{31} - {2}^{25} - \\ {2}^{19} + {2}^{15} + {2}^{9} + {2}^{3} ) ≫ 17 \\ = ( 135233 * x [ 15 : 0 ] + 33288 * \overline{x [ 15 : 0 ]} - 2181529080 ) ≫ 17\end{matrix}$$

This is an array with maximum height 8 (including constant) array with total width 33 and 7*16=112 partial product bits. We will now compare this array to an array generated starting from a binary expansion of the constant rational according to the principles described herein.

Consider the constant rational

$$\frac{p}{q} = \frac{7}{9} :$$

$$\frac{7}{9} = \frac{1}{{2}^{i}} ( ⌊ \frac{7}{9} ⌋ + \frac{7 mod 9}{9} ) = \frac{1}{{2}^{0}} ( 0 + \frac{7 mod 9}{9} ) = \frac{7}{9}$$

Group theory guarantees that 2⁶ mod 9=1, which is true since 2⁶=7*9+1 (the value n=6 is also in this case the smallest factor of 6 {1,2,3,6} for which this holds), so

$$\frac{7}{9} = \frac{7}{7} * \frac{7}{9} = \frac{49}{{2}^{6} - 1} = 0. \dot{1} 1000 \dot{1}$$

as a binary expansion (this is not in CSD form since it includes two adjacent 1s).

The CSD form of 49 is CSD (49)=10S0001 which is a 7-bit value, which overflows the 6-bit number space

$$( indeed 49 \geq ⌈ \frac{{2}^{7}}{3} ⌉ = 43 ) .$$

We therefore consider −CSD(63−49)=CSD (−14)=0S0010 which does not overflow and further satisfies the requirement that the number can be repeated in groups of 6 in an infinite sequence without violating the CSD form which does not allow adjacent 1s so to give

$$\frac{- 14}{{2}^{6} - 1} = \dot{0} S 001 \dot{0} .$$

Following equations (10) above gives:

$$\begin{matrix}\frac{7}{9} = \frac{49}{{2}^{6} - 1} \\ = ( ( 0 + 1 - \frac{14}{{2}^{6}} ) - ( \frac{14}{{2}^{6} ( {2}^{6} - 1 )} ) ) \\ = ( \frac{1}{{2}^{6}} CSD ( 49 ) + \frac{1}{{2}^{6}} \frac{CSD ( - 14 )}{{2}^{6} - 1} ) \\ ( \frac{65 - 16}{{2}^{6}} + \frac{1}{{2}^{6}} \frac{- 16 + 2}{{2}^{6} - 1} ) \\ = 1. \dot{0} S 001 \dot{0}\end{matrix}$$

$$\begin{matrix}\frac{7}{9} * x [ 15 : 0 ] = x [ 15 : 0 ] + \frac{2 * x [ 15 : 0 ]}{{2}^{6} - 1} + \frac{16 * ( - x [ 15 : 0 ] )}{{2}^{6} - 1} \\ = x [ 15 : 0 ] + \frac{2 * x [ 15 : 0 ]}{{2}^{6} - 1} + \frac{16 * ( - {2}^{16} + 1 + \overline{x [ 15 : 0 ]} )}{{2}^{6} - 1} \\ = x [ 15 : 0 ] + \frac{{2}^{1} * x [ 15 : 0 ]}{{2}^{6} - 1} + \frac{{2}^{4} * \overline{x [ 15 : 0 ]}}{{2}^{6} - 1} + \frac{{2}^{4} * ( - {2}^{16} + 1 )}{{2}^{6} - 1} \\ = x [ 15 : 0 ] + {\sum }_{i = 1}^{∞} x [ 15 : 0 ] * {2}^{- 6 i + 1} + {\sum }_{i = 1}^{∞} \overline{x [ 15 : 0 ]} * {2}^{- 6 i + 4} + τ\end{matrix}$$

Using the efficient truncation approach described above and the result at equation (26) identifies a suitable column below the binary point at which to start the truncation search: this is column 2^{-k} where k=└ ln₂(m*q)┘+1=└ ln₂(16*9)┘+1=8—i.e. 8 bits below the binary point. Every bit less significant than this column can be safely removed in the knowledge that

$${Δ}_{h i g h} - {Δ}_{l o w} < \frac{1}{9} .$$

Thus rₐ=0 and r_{b}= 1/9 and our condition for the corrective constant c is Δ_{low}+ 1/9>c≥Δ_{high} and Δ(x) for x_{high} and x_{low} is given by:

$${Δ}_{high / low} = \frac{7 * {x}_{high / low}}{9} - {( \frac{7 * {x}_{high / low}}{9} )}_{finite}$$

From the columns in the removed set (those with weight 2⁻⁹ and below) we see that Δ_{high}= 1/56 when x=x_{high}=0111000111000111=29127 and

$${Δ}_{l o w} = \frac{1}{448}$$

when=x_{low}=x̅_̅{̅h̅i̅g̅h̅}̅=1000111000111000=36408. So

$${Δ}_{h i g h} - {Δ}_{l o w} = \frac{1}{56} - \frac{1}{448} = \frac{1}{64} < \frac{1}{9}$$

as expected.

Removing another column (the 2⁻⁸ weight column) we get

$${Δ}_{h i g h} = \frac{39}{1008}$$

when x=x_{high}=1110001110001110=58254 and

$${Δ}_{l o w} = \frac{39}{8064}$$

when=x_{low}=x̅_̅{̅h̅i̅g̅h̅}̅=0001110001110001=7281. So

$${Δ}_{h i g h} - {Δ}_{l o w} = \frac{39}{1008} - \frac{39}{8064} = \frac{39}{1152} < \frac{1}{9} .$$

Removing the next most significant column (the 2⁻⁷ weight column), we still find that

$${Δ}_{h i g h} - {Δ}_{l o w} = \frac{37}{576} < \frac{1}{9} ,$$

so we move onto trying to remove the whole of the 2⁻⁶ column of the finite array. We get Δ_{high}= 1/7 when x=x_{high}=1000111000111000=36408 and, Δ_{low}= 1/56 when=x_{low}−x̅_̅{̅h̅i̅g̅h̅}̅=0111000111000111=29127. So Δ_{high}−Δ_{low}= 1/7− 1/56=⅛≥ 1/9 and it is necessary to keep some bits in the 2⁻⁶ column in order to ensure Δ_{high}−Δ_{low}< 1/9. In this case it is therefore possible to remove two further columns whilst maintaining the desired accuracy of the array.

In this particular example, removing any bit from the 2⁻⁶ column has the same effect (due to the recurring symmetry of the particular CSD array) as increasing the value of Δ_{high}−Δ_{low} by 7/576 so only 3 can be removed to make Δ_{high}−Δ_{low}= 29/288< 1/9. Removing an additional bit would make

$${Δ}_{h i g h} - {Δ}_{l o w} = \frac{29}{288} + \frac{7}{576} = \frac{65}{576} \geq \frac{1}{9} .$$

It is most sensible to remove x̅[̅1̅4̅]̅, x[11] and x̅[̅8̅]̅ since these are the bits of x which are the most significant and are likely to cause the most fan-out in a hardware implementation of the finite truncated CSD array. Doing so gives Δ_{high}= 29/252 when x=x_{high}=1000111000011100=36380 and Δ_{low}= 29/2016 when x=x_{low}=x̅_̅{̅h̅i̅g̅h̅}̅=0111000111100011=29155 (so we recover that

$${Δ}_{h i g h} - {Δ}_{l o w} = \frac{29}{252} - \frac{29}{2016} = \frac{8 * 29}{2016} - \frac{29}{2016} = \frac{7 * 29}{2016} = \frac{29}{288} ) .$$

This gives the condition on the corrective constant that:

$$\frac{29}{2016} + \frac{1}{9} = \frac{29}{2016} + \frac{224}{2016} = \frac{253}{2016} > c \geq \frac{232}{2016} = \frac{29}{252}$$

and adding c to τ to give z=τ+c gives us:

$$\frac{253}{2016} + \frac{{2}^{4} * ( - {2}^{16} + 1 )}{{2}^{6} - 1} > z \geq \frac{29}{252} + \frac{{2}^{4} * ( - {2}^{16} + 1 )}{{2}^{6} - 1} - \frac{4793381}{288} > z \geq - \frac{4793384}{288} = - \frac{599173}{36}$$

Truncating z′ to 6 fractional bits (to match the width of the finite CSD array) with floor/RTNI rounding (e.g. by removing isolated positive bits which can't cause carries) in this particular case gives two possible values for

$${z}^{′} = \frac{⌊ {2}^{6} {z}^{′} ⌋}{{2}^{6}} :$$

$${z}_{max}^{′} = - \frac{1065196}{{2}^{6}} and {z}_{min}^{′} = - \frac{1065197}{{2}^{6}} .$$

Choosing z′ₘₐₓ, the larger of the two values of z′, it is possible to remove one of the additional bits from the 2⁻⁶ column x[5] or x̅[̅2̅]̅. Sticking with our earlier heuristic, it is advantageous to choose x[5] as that has the higher index number.

Since

$${z}^{′} = {z}_{max}^{′} = - \frac{1065196}{{2}^{6}}$$

is an even multiple of 2⁻⁶ (it has a 0 in the 2⁻⁶ column), bit x̅[̅2̅]̅ is now ‘isolated’ in this column—it is the only bit that can take a non-zero value and hence can't generate any carries to the left to affect the value of y[15:0], so in this unusual case, due to the particular values of p, q and the input being a Um number, it is also possible to remove this bit and therefore the entire 2⁻⁶ column can be removed, without affecting the output. The new, now unique, value of z′ is therefore

$${z}^{′} = - \frac{532598}{{2}^{5}} .$$

In this case the final array has a maximum height 7 (one row being the constant z′), width 21 and a partial product count of 83, which is fewer than that of the multiply-add-shift array and, when implemented in hardware as fixed logic, will consume a smaller chip area and offer lower latency. The additive array generated in this particular example can be expressed as:

$$y [ 15 : 0 ] := RTNI ( \frac{84 * x [ 15 : 0 ]}{108} ) = ( ( x [ 15 : 0 ] ≪ 5 ) + ( \overline{x [ 15 : 0 ]} ≪ 3 ) + x [ 15 : 0 ] + \overline{x [ 15 : 3 ]} + x [ 15 : 6 ] + \overline{x [ 15 : 9 ]} + x [ 15 : 12 ] + \overline{x [ 15 ]} - 5325 \; 98 ) ≫ 5$$

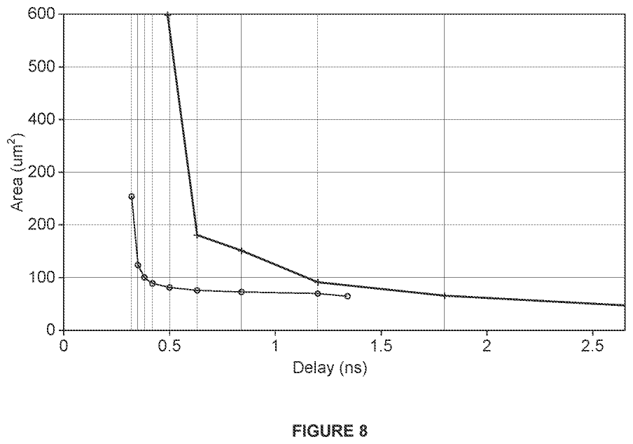

FIG. 8 illustrates the area and delay advantages of implementing the multiplication by a constant fraction operation of the present example using a 16 nm process as a fixed logic circuit according to the principles taught herein—i.e. p=7, q=9, m=16. In the figure the area-delay curve having cross data points represents a conventional fixed logic circuit implementing multiplication by a constant fraction using a conventional multiply-add-shift approach. In the figure the area-delay curve having circle data points represents a fixed logic circuit implementing multiplication by a constant fraction according to the principles described herein. It will be appreciated that the area and delay are lower for a fixed logic circuit implementing multiplication by a constant fraction according to the principles described herein.

### Generating a Hardware Representation

The truncated addition arrays described herein for performing multiplication by a constant fraction may be determined by suitable software. Typically, integrated circuits are initially designed using software (e.g. Synopsys® Design Compiler®) that generates a functional description of the desired integrated circuit in a hardware description language, such as a Register-Transfer Level (RTL) description. Once the logical operation of the integrated circuit has been defined, this can be used by synthesis software (e.g. Synopsys® IC Compiler™) to create representations of the physical integrated circuit embodying the defined functionality. Such representations can be defined in high level hardware description languages, for example Verilog or VHDL and, ultimately, according to a gate-level description of the integrated circuit.

Logic for performing multiplication by a constant rational/fraction can be readily introduced into an integrated circuit at design time. However, the design software used for designing integrated circuits will almost invariably provide the functionality using logic for performing generic division—i.e. logic for performing division by a divisor specified at runtime. Such logic is complex and consumes a significant area of integrated circuit.

It is advantageous if tools for designing integrated circuits are configured to, on a multiplication by a constant rational/fraction operation being specified by the designer, implement the operation as a truncated array in accordance with the design principles described herein. An exemplary hardware design system 600 is shown in FIG. 6 which comprises a truncated array generator 602 that is configured to generate RTL defining a truncated array according to the principles set out herein for synthesis at an RTL synthesiser 604—e.g. so as to generate, for example, a gate level netlist or other hardware description. The truncated array generator 602 receives as inputs constants p and q defining the rational p/q, the length m of the input x and, for example an identification of the rounding mode which is to be applied to the operation. The hardware design system may comprise, for example, one or more of software, hardware and firmware configured to implement the design principles described herein. The hardware design system may represent software for execution at apparatus comprising a processor and a memory.

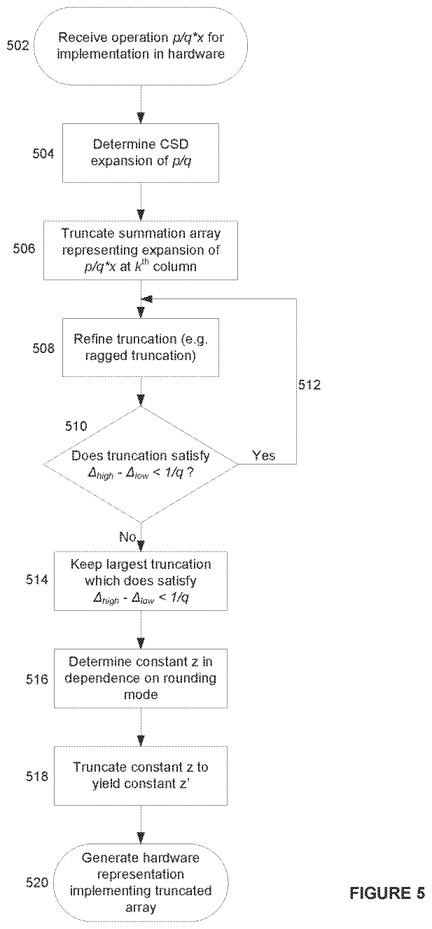

A method of deriving a hardware representation of a binary logic circuit in accordance with the principles set out herein is illustrated in the flowchart of FIG. 5. At 502, a multiplication by a constant fraction operation

$$\frac{p x}{q}$$

is received which is to be implemented in hardware. An expansion of the rational p/q is determined at 504 in CSD form. This could be performed in any suitable manner—for example, in accordance with equation (7) above. For non-trivial cases this expansion will be infinite and cannot therefore be implemented in hardware. At 506, a suitable column is identified to provide a starting point at which truncation is to be performed so as to remove an infinite number of partial products and form a finite array.

The truncation is performed so as to discard at least the column of the array k=└ ln₂ (mq)┘+1 columns below the binary point of the array and all less significant columns, as described above in relation to equation (26). It is advantageous if the truncation is performed at the k^{th} column because this always ensures that for all p, q, m, x the output y is accurate over its t bits provided that a suitable constant correction is included in the array (see discussion of z′ above). It will be understood that it is not necessary to form the infinite array in order to discard columns from it—i.e. it is not necessary for the discarded columns to exist as any kind of representation in order for them to be discarded. Forming a truncated array by “discarding” columns may refer to forming a truncated array which does not (and never did) include the discarded columns.

Further truncation 508 may subsequently be performed so as further reduce the size of the array—for example, ragged truncation of the columns may be performed in accordance with the heuristics described herein. Importantly, each truncation must satisfy

$$\frac{1}{q} > {Δ}_{h i g h} - {Δ}_{l o w}$$

so as to ensure mat the output is correct for all possible inputs x. Thus, for example, after each truncation a check 510 may be performed so as to determine whether

$$\frac{1}{q} > {Δ}_{h i g h} - {Δ}_{l o w}$$

is satisfied: if so, a further truncation iteration 512 is performed; if not, the latest truncation is rejected and the preceding truncation (which satisfied

$$\frac{1}{q} > {Δ}_{h i g h} - {Δ}_{l o w} )$$

is kept 514 as the minimal size of the array. The values of Δ_{high} and Δ_{low} may be calculated using equations (11 b) and (11c) above.

Once the complete set of partial products of

$$\frac{p}{q} * x$$

has been established, a corrective constant z is determined 516 in dependence on the desired rounding mode. By ensuring that the inequality

$$\frac{1}{q} > {Δ}_{h i g h} - {Δ}_{l o w}$$

is satisfied for the truncated array, a value z is guaranteed to exist which ensures that the truncated array correctly calculates the output y for all inputs X. Any suitable method may be used to identify such a value Z. For example, the methods described herein may be followed according to equations (10) and (15)/(19)/(23) according to the rounding mode to be implemented, noting that z=τ+C. As described herein, z may be truncated 518 to the number of columns of the array of partial products of x.

Once the complete truncated array of partial products of the input x and the (possibly truncated) constant z′ have been derived, a hardware representation (e.g. RTL) of the truncated array may be generated 520 for synthesis in hardware as a fixed logic circuit. A fixed logic circuit refers to a circuit in which the low-level logic is adapted to perform an operation or set of operations which are fixed at manufacture of the circuit. Synthesis of the logic from the hardware representation may be performed in any suitable manner, as is well known in the art (e.g. through the use of suitable synthesis tools).

The hardware representation of the binary logic circuit could be provided (typically as part of a larger-scale chip design) for fabrication into an integrated circuit. For example, a low-level representation of an IC could be provided directly to a foundry for fabrication of the specified integrated circuit, or RTL could be provided to an intermediate chip designer who would themselves design a low-level representation of an IC from the RTL for provision to a foundry.

It is to be noted that whilst the present disclosure refers to performing operations on an array and its values in respect of steps 504 to 518, neither the array nor any intermediate forms of the array may exist prior to generation of the hardware representation of the array.

### General Statements

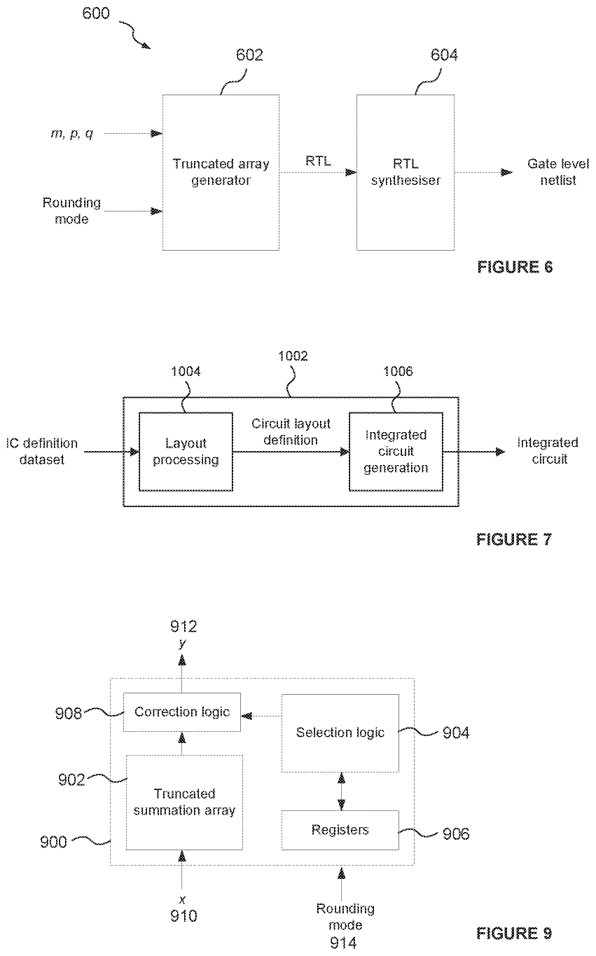

FIGS. 6 and 7 are shown as comprising a number of functional blocks. This is schematic only and is not intended to define a strict division between different logic elements. Each functional block may be provided in any suitable manner. It is to be understood that intermediate values or arrays described herein as being formed as part of the methods described herein need not be physically generated at any point.

The methods described herein are for generating logic suitable for inclusion in an integrated circuit. Generally, any of the functions, methods, techniques or components described above can be implemented in software, firmware, hardware (e.g., fixed logic circuitry), or any combination thereof. The terms “module,” “functionality,” “component”, “element”, “unit”, “block” and “logic” may be used herein to generally represent software, firmware, hardware, or any combination thereof. In the case of a software implementation, the module, functionality, component, element, unit, block or logic represents program code that performs the specified tasks when executed on a processor. The algorithms and methods described herein could be performed by one or more processors executing code that causes the processor(s) to perform the algorithms/methods. Examples of a computer-readable storage medium include a random-access memory (RAM), read-only memory (ROM), an optical disc, flash memory, hard disk memory, and other memory devices that may use magnetic, optical, and other techniques to store instructions or other data and that can be accessed by a machine.

The terms computer program code and computer readable instructions as used herein refer to any kind of executable code for processors, including code expressed in a machine language, an interpreted language or a scripting language. Executable code includes binary code, machine code, bytecode, code defining an integrated circuit (such as a hardware description language or netlist), and code expressed in a programming language code such as C, Java or OpenCL. Executable code may be, for example, any kind of software, firmware, script, module or library which, when suitably executed, processed, interpreted, compiled, executed at a virtual machine or other software environment, cause a processor of the computer system at which the executable code is supported to perform the tasks specified by the code.

A processor, computer, or computer system may be any kind of device, machine or dedicated circuit, or collection or portion thereof, with processing capability such that it can execute instructions. A processor may be or comprise any kind of general purpose or dedicated processor, such as a CPU, GPU, NNA, System-on-chip, state machine, media processor, an application-specific integrated circuit (ASIC), a programmable logic array, a field-programmable gate array (FPGA), or the like. A computer or computer system may comprise one or more processors.

It is also intended to encompass software which defines a configuration of hardware as described herein, such as HDL (hardware description language) software, as is used for designing integrated circuits, or for configuring programmable chips, to carry out desired functions. The output of the methods and hardware design system described herein may be provided on a computer readable storage medium having encoded thereon computer readable program code in the form of an integrated circuit definition dataset that when processed (i.e. run) in an integrated circuit manufacturing system configures the system to manufacture fixed logic circuits for performing multiplication by a constant rational as described herein. An integrated circuit definition dataset may be, for example, an integrated circuit description.

Therefore, there may be provided a method of manufacturing, at an integrated circuit manufacturing system, a fixed logic circuit as described herein. Furthermore, there may be provided an integrated circuit definition dataset that, when processed in an integrated circuit manufacturing system, causes the method of manufacturing a fixed logic circuit to be performed.

An integrated circuit definition dataset may be in the form of computer code, for example as a netlist, code for configuring a programmable chip, as a hardware description language defining hardware suitable for manufacture in an integrated circuit at any level, including as register transfer level (RTL) code, as high-level circuit representations such as Verilog or VHDL, and as low-level circuit representations such as OASIS® and GDSII. Higher level representations which logically define hardware suitable for manufacture in an integrated circuit (such as RTL) may be processed at a computer system configured for generating a manufacturing definition of an integrated circuit in the context of a software environment comprising definitions of circuit elements and rules for combining those elements in order to generate the manufacturing definition of an integrated circuit so defined by the representation. As is typically the case with software executing at a computer system so as to define a machine, one or more intermediate user steps (e.g. providing commands, variables etc.) may be required in order for a computer system configured for generating a manufacturing definition of an integrated circuit to execute code defining an integrated circuit so as to generate the manufacturing definition of that integrated circuit.

An example of processing an integrated circuit definition dataset at an integrated circuit manufacturing system so as to configure the system to manufacture a fixed logic circuit will now be described with respect to FIG. 7.

FIG. 7 shows an example of an integrated circuit (IC) manufacturing system 1002 which is configured to manufacture a fixed logic circuit as described in any of the examples herein. In particular, the IC manufacturing system 1002 comprises a layout processing system 1004 and an integrated circuit generation system 1006. The IC manufacturing system 1002 is configured to receive an IC definition dataset (e.g. defining a fixed logic circuit as described in any of the examples herein), process the IC definition dataset, and generate an IC according to the IC definition dataset (e.g. which embodies a fixed logic circuit as described in any of the examples herein). The processing of the IC definition dataset configures the IC manufacturing system 1002 to manufacture an integrated circuit embodying a fixed logic circuit as described in any of the examples herein.

The layout processing system 1004 is configured to receive and process the IC definition dataset to determine a circuit layout. Methods of determining a circuit layout from an IC definition dataset are known in the art, and for example may involve synthesising RTL code to determine a gate level representation of a circuit to be generated, e.g. in terms of logical components (e.g. NAND, NOR, AND, OR, MUX and FLIP-FLOP components). A circuit layout can be determined from the gate level representation of the circuit by determining positional information for the logical components. This may be done automatically or with user involvement in order to optimise the circuit layout. When the layout processing system 1004 has determined the circuit layout it may output a circuit layout definition to the IC generation system 1006. A circuit layout definition may be, for example, a circuit layout description.

The IC generation system 1006 generates an IC according to the circuit layout definition, as is known in the art. For example, the IC generation system 1006 may implement a semiconductor device fabrication process to generate the IC, which may involve a multiple-step sequence of photo lithographic and chemical processing steps during which electronic circuits are gradually created on a wafer made of semiconducting material. The circuit layout definition may be in the form of a mask which can be used in a lithographic process for generating an IC according to the circuit definition. Alternatively, the circuit layout definition provided to the IC generation system 1006 may be in the form of computer-readable code which the IC generation system 1006 can use to form a suitable mask for use in generating an IC.

The different processes performed by the IC manufacturing system 1002 may be implemented all in one location, e.g. by one party. Alternatively, the IC manufacturing system 1002 may be a distributed system such that some of the processes may be performed at different locations, and may be performed by different parties. For example, some of the stages of: (i) synthesising RTL code representing the IC definition dataset to form a gate level representation of a circuit to be generated, (ii) generating a circuit layout based on the gate level representation, (iii) forming a mask in accordance with the circuit layout, and (iv) fabricating an integrated circuit using the mask, may be performed in different locations and/or by different parties.

In other examples, processing of the integrated circuit definition dataset at an integrated circuit manufacturing system may configure the system to manufacture a fixed logic circuit without the IC definition dataset being processed so as to determine a circuit layout. For instance, an integrated circuit definition dataset may define the configuration of a reconfigurable processor, such as an FPGA, and the processing of that dataset may configure an IC manufacturing system to generate a reconfigurable processor having that defined configuration (e.g. by loading configuration data to the FPGA).

In some embodiments, an integrated circuit manufacturing definition dataset, when processed in an integrated circuit manufacturing system, may cause an integrated circuit manufacturing system to generate a device as described herein. For example, the configuration of an integrated circuit manufacturing system in the manner described above with respect to FIG. 7 by an integrated circuit manufacturing definition dataset may cause a device as described herein to be manufactured.

In some examples, an integrated circuit definition dataset could include software which runs on hardware defined at the dataset or in combination with hardware defined at the dataset. In the example shown in FIG. 7, the IC generation system may further be configured by an integrated circuit definition dataset to, on manufacturing an integrated circuit, load firmware onto that integrated circuit in accordance with program code defined at the integrated circuit definition dataset or otherwise provide program code with the integrated circuit for use with the integrated circuit.

The implementation of concepts set forth in this application in devices, apparatus, modules, and/or systems (as well as in methods implemented herein) may give rise to performance improvements when compared with known implementations. The performance improvements may include one or more of increased computational performance, reduced latency, increased throughput, and/or reduced power consumption. During manufacture of such devices, apparatus, modules, and systems (e.g. in integrated circuits) performance improvements can be traded-off against the physical implementation, thereby improving the method of manufacture. For example, a performance improvement may be traded against layout area, thereby matching the performance of a known implementation but using less silicon. This may be done, for example, by reusing functional blocks in a serialised fashion or sharing functional blocks between elements of the devices, apparatus, modules and/or systems. Conversely, concepts set forth in this application that give rise to improvements in the physical implementation of the devices, apparatus, modules, and systems (such as reduced silicon area) may be traded for improved performance. This may be done, for example, by manufacturing multiple instances of a module within a predefined area budget.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein. In view of the foregoing description it will be evident to a person skilled in the art that various modifications may be made within the scope of the invention.

What is claimed is:

1. A fixed logic circuit for performing multiplication of an input x by a constant rational p/q so as to calculate an output y according to a directed rounding or round-to-nearest rounding mode, where p,q are coprime integers, and x is an m-bit input, the fixed logic circuit comprising:
a truncated summation array of a finite sequence of most significant bits of an infinite CSD expansion of the rational p/q operating on the bits of the input x, the truncated summation array satisfying
$${Δ}_{h i g h} - {Δ}_{l o w} < \frac{1}{q} ,$$
where, for all x, Δ_{high} is the maximum sum of the partial products of the bits of the infinite CSD expansion not included in the array and Δ_{low} is the minimum sum of the partial products of the bits of the infinite CSD expansion not included in the array;
registers defining a plurality of corrective constants for a respective plurality of rounding modes, each corrective constant being for use in the fixed logic circuit when the fixed logic circuit is operating in the rounding mode such that the output y is correct for all x; and
selection logic configured to, in dependence on a rounding mode in which the truncated summation array is to operate, select the respective corrective constant for that rounding mode.

2. The fixed logic circuit as claimed in claim 1, wherein the plurality of corrective constants are each for addition with the output of the truncated summation array.

3. The fixed logic circuit as claimed in claim 1, wherein the selection logic is configured to select the respective corrective constant for the rounding mode by appropriately configuring a plurality of gates of the fixed logic circuit.

4. The fixed logic circuit as claimed in claim 3, wherein the registers define a plurality of configurations of the plurality of gates of the fixed logic circuit, each of the plurality of configurations representing a respective corrective constant of the plurality of corrective constants.

5. The fixed logic circuit as claimed in claim 3, further comprising a set of configurable registers arranged to control a plurality of gates of the fixed logic circuit, the selection logic being configured to set the configurable registers according to the selected respective corrective constant.

6. The fixed logic circuit as claimed in claim 1, further comprising a set of configurable registers arranged for summation with the truncated summation array, the selection logic being configured to set the configurable registers according to the selected respective corrective constant.

7. The fixed logic circuit as claimed in claim 6, wherein the set of configurable registers are arranged for summation with the truncated summation array such that all the configurable registers are arranged for summation with columns at least as significant as the least significant column of the truncated summation array.

8. The fixed logic circuit as claimed in claim 1, wherein each of the plurality of corrective constants z is defined at a precision commensurate with the truncated summation array.

9. The fixed logic circuit as claimed in claim 1, wherein the plurality of corrective constants comprises one or more of the following constants c:
$$for RTNI rounding , {Δ}_{l o w} + \frac{1}{q} > c \geq {Δ}_{h i g h} ;$$
$$for RTPI rounding , {Δ}_{l o w} + 1 > c \geq {Δ}_{h i g h} + \frac{q - 1}{q} ;$$
$$for RTU rounding , {Δ}_{l o w} + 1 - \frac{⌈ \frac{q}{2} ⌉ - 1}{q} > c \geq {Δ}_{h i g h} + 1 - \frac{⌈ \frac{q}{2} ⌉}{q} .$$

10. The fixed logic circuit as claimed in claim 1, further comprising one or more mode registers configurable at run time so as to indicate the rounding mode in which the truncated summation array is to operate, the selection logic being configured to select the respective corrective constant in dependence on the rounding mode indicated by the one or more mode registers.

11. The fixed logic circuit as claimed in claim 1, further comprising correction logic configured to sum the selected corrective constant with the output of the truncated summation array to generate the output y.

12. The fixed logic circuit as claimed in claim 1, wherein the directed rounding mode is one of: round towards zero; round towards negative infinity; round towards positive infinity; and round away from zero.

13. The fixed logic circuit as claimed in claim 1, wherein the round-to-nearest rounding mode is one of: round to nearest, ties up; round to nearest, ties down; round to nearest, ties towards zero; round to nearest, ties away from zero; round to nearest, ties to even; and round to nearest, ties to odd.

14. A processor comprising the fixed logic circuit as claimed in claim 1.

15. A method of manufacturing, using an integrated circuit manufacturing system, a fixed logic circuit as set forth in claim 1, the method comprising:
processing, using a layout processing system, a computer readable dataset description of the fixed logic circuit so as to generate a circuit layout description of an integrated circuit embodying the fixed logic circuit; and
manufacturing, using an integrated circuit generation system, the fixed logic circuit according to the circuit layout description.

16. A non-transitory computer readable storage medium having stored thereon an integrated circuit definition dataset that, when processed in an integrated circuit manufacturing system, configures the integrated circuit manufacturing system to manufacture a fixed logic circuit as set forth in claim 1.

17. A non-transitory computer readable storage medium having stored thereon a computer readable dataset description of a fixed logic circuit for performing multiplication of an input x by a constant rational p/q so as to calculate an output y according to a directed rounding or round-to-nearest rounding mode, where p, q are coprime integers, and x is an m-bit input, the fixed logic circuit comprising:
a truncated summation array of a finite sequence of most significant bits of an infinite CSD expansion of the rational p/q operating on the bits of the input x, the truncated summation array satisfying
$${Δ}_{h i g h} - {Δ}_{l o w} < \frac{1}{q} ,$$
where, for all x, Δ_{high} is the maximum sum of the partial products of the bits of the infinite CSD expansion not included in the array and Δ_{low} is the minimum sum of the partial products of the bits of the infinite CSD expansion not included in the array;
registers defining a plurality of corrective constants for a respective plurality of rounding modes, each corrective constant being for use in the fixed logic circuit when the fixed logic circuit is operating in the rounding mode such that the output y is correct for all x; and
selection logic configured to, in dependence on a rounding mode in which the truncated summation array is to operate, select the respective corrective constant for that rounding mode;
whereby the computer readable description, when processed in an integrated circuit manufacturing system, causes the integrated circuit manufacturing system to manufacture an integrated circuit embodying the fixed logic circuit.

18. A non-transitory computer readable storage medium having stored thereon a computer readable dataset description of a fixed logic circuit as set forth in claim 1 which, when processed in an integrated circuit manufacturing system, causes the integrated circuit manufacturing system to:
process, using a layout processing system, the computer readable description of the fixed logic circuit so as to generate a circuit layout description of an integrated circuit embodying the fixed logic circuit; and
manufacture, using an integrated circuit generation system, the fixed logic circuit according to the circuit layout description.

19. An integrated circuit manufacturing system configured to manufacture a graphics processing system as set forth in claim 1.

20. An integrated circuit manufacturing system comprising:
a non-transitory computer readable storage medium having stored thereon a computer readable dataset description of a fixed logic circuit as claimed in claim 1;
a layout processing system configured to process the computer readable description so as to generate a circuit layout description of an integrated circuit embodying the fixed logic circuit; and
an integrated circuit generation system configured to manufacture the fixed logic circuit according to the circuit layout description.
